(19) United States
(12) Patent Application Publication
(10) Pub. No.: US 2022/0252764 A1
(43) Pub. Date: Aug. 11, 2022

(54) LUMINAIRE FOR IRRADIATING A TARGET

(71) Applicant: Heraeus Noblelight GmbH, Hanau (DE)

(72) Inventors: Jochen GRADE, Hanau (DE); Janek DESGRONTE, Hanau (DE); Andreas STAHL, Frankfurt am Main (DE)

(21) Appl. No.: 17/413,252

(22) PCT Filed: Dec. 10, 2019
(86) PCT No.: PCT/EP2019/084394

§ 371 Date: Jun. 11, 2021

(30) Foreign Application Priority Data
Dec. 14, 2018 (DE) 10 2018 221 729.7

(51) Int. Cl. G02B 3/00; G02B 7/02; G02B 19/00; G02B 27/09; B41F 23/04

(52) U.S. Cl. CPC G02B 3/005; G02B 7/021; G02B 7/023; G02B 19/0095; G02B 27/0966; B41F 23/0406; G02B 19/0066

(57) ABSTRACT

A luminaire for irradiating a target such as a printed product with printed-on lacquer or the like. The luminaire has a plurality of semiconductor light sources, wherein at least two first semiconductor light sources form a first light source line oriented in a lateral direction and wherein at least two further semiconductor light sources form a second light source line oriented in the lateral direction. The luminaire also has a plurality of separate lenses for collimating and/or collecting light from the semiconductor light sources, wherein each of the light source lines is assigned to one of the lenses.

### CROSS REFERENCE TO RELATED APPLICATIONS

This application is a U.S. national phase filing of International Patent Application Number PCT/EP2019/084394 filed on Dec. 10, 2019, which claims priority to German Patent Application Number 102018221729.7 filed on Dec. 14, 2018. The disclosures of these applications are hereby incorporated by reference in their entirety.

### TECHNICAL FIELD

The invention relates to a luminaire for irradiating a target such as a printed product with printed-on lacquer, printed-on ink, or the like. The invention can also relate to a printing machine having at least one or more luminaires for irradiating a printed product.

### BACKGROUND

Printing machines with luminaires for irradiating printed products with printed-on lacquer, printed-on ink, or the like, for curing the lacquer or drying the ink, are known. Against the background of economical manufacturing, it is desirable to irradiate the target, for example a paper web, sufficiently intensely such that rapid curing or drying is ensured in order to allow the target to be conveyed and processed at a high speed, usually several meters per second. To this end, conventional printing machines extensively make use of mercury vapor emitters. From an ecological point of view, it is desirable to use mercury-free emitters, for example semiconductor light sources such as light-emitting diode (LED) light sources or semiconductor lasers such as vertical-cavity surface-emitting lasers (VCSELs).

Semiconductor light sources can have substantially Lambertian emission patterns. Therefore, a problem arising within the scope of ultraviolet (UV) curing is that of supplying uniform irradiance to a target item or a target surface. There are different approaches for directing the light of semiconductor light sources in printing machines.

DE 21 2013 000 099 U1 discloses an illumination system for use in the production of coatings, print ink, adhesives, and other curable substances. The illumination system is equipped with a housing that contains a linear arrangement of light-emitting elements, a window, and a front cover. The intention is for the illumination system to comprise a directing optical unit in the form of a linear Fresnel cylindrical lens with one or more grooves. DE 21 2013 000 099 U1 describes Fresnel cylindrical lenses made of glass, the intention being for these lenses to be manufactured by a blank pressing process. It is practically impossible to produce Fresnel lenses, particularly those having a plurality of grooves made of glass, in an economical fashion using conventional processes because it is difficult to precisely obtain the fine, sharp edges by way of blank pressing. By way of example, the Fresnel cylindrical lens may be manufactured from an optically transparent plastic. However, such plastic lenses lack mechanical stability, particularly at relatively high temperatures above approximately 120° C. Further, the described optical units provide for a relatively long path between the light source and the lens, negatively affecting the achievable directing effect.

WO 2013/164054 A1 discloses a method for producing an optical module with a polymer optical unit, which is held on a substrate made of glass. In comparison with the above-described optical unit, such optical modules can be produced more cost-effectively with a higher precision. The substrate made of glass provides a high degree of structural stability for the effective optical module, made of a transparent silicone material, applied thereon. A disadvantage remaining in the case of this optical module is the relatively large distance between the semiconductor light source and the effective optical module as a result of the substrate.

US 2011/0290179 A1 describes a curing apparatus having numerous UV LEDs. The ultraviolet radiation emitted by the UV LEDs is focused by a multipart parabolic mirror and a single cylindrical lens on a flat printed product at a relatively large distance from the UV LEDs. The large distances in the radiation direction have as a consequence a poor directing effect and an undesirably large installation space.

WO 2013/164053 A1 describes a luminaire having a primary optical unit for focusing the light emitted by LED light sources, comprising a plurality of lenses that are arranged directly on the LEDs and, where applicable, reflectors that are arranged directly to the side of the LEDs, which form a primary optical unit. In addition to the primary optical unit, a secondary optical unit is provided which enhances the focusing of the largest possible emergence angle from the LEDs onto a target surface. By way of example, the secondary optical unit can be embodied as described in WO 2013/164053 A1. The luminaire described in WO 2013/164053 A1 is distinguished by very good optical properties. However, it was found that the silicone optical unit can be heated to temperatures above its autoignition temperature in the case of particularly high power of the semiconductor light sources. The lenses are heated, firstly, by heating the LEDs with which the polymer lenses are in direct contact and, secondly, by the absorbed radiation. The transmission of silicone is approximately 90-92%, i.e., approximately 10% of the radiant flux is converted into heat in the silicone.

It is an object of the invention to provide a luminaire for irradiating a target using semiconductor light sources, which luminaire overcomes the disadvantages of the prior art, in particular provides high mechanical and thermal stability in combination with good optical directing properties and/or can be produced precisely in a cost-effective fashion. This object is achieved by the disclosed subject matter.

### SUMMARY OF THE INVENTION

The invention relates to a luminaire for irradiating a target such as a printed product with printed-on lacquer or the like. In general, a radiation source is referred to as a luminaire. The luminaire can be designed to emit light predominantly or exclusively from one or more specific spectral ranges. By way of example, the luminaire can be an infrared emitter (IR emitter), which predominantly or exclusively emits light with wavelengths in the infrared spectral range, in particular in the range from 780 nm or from 800 nm and/or up to 1,600 nm, in particular up to 1,300 nm, preferably up to 1,000 nm. By way of example, the luminaire can be an ultraviolet emitter (UV emitter), which predominantly or exclusively emits light with wavelengths in the ultraviolet spectral range, in particular in the range from 140 nm, in particular from 180 nm, preferably from 210 nm and/or up to 470 nm, in particular up to 400 nm, preferably up to 390 nm. In this context, predominantly means that at least 50%, in particular at least 75%, of the emission spectrum lies in the specified wavelength range. According to one embodiment, a UV semiconductor light source can provide for a spectral range of at least 380 nm and no more than 390 nm.

The luminaire comprises a plurality of semiconductor light sources. By way of example, the semiconductor light sources can be embodied as infrared light-emitting diodes (IR LEDs) and/or as ultraviolet light-emitting diodes (UV LEDs). By way of example, the semiconductor light sources can be vertical-cavity surface-emitting lasers (VCSELs).

At least two first semiconductor light sources form a first light source line which is oriented in a lateral direction and at least two further semiconductor light sources form a second light source line which is oriented in the lateral direction. At least two semiconductor light sources can be located on a straight line, which corresponds to the lateral direction, and can form the first light source line. The luminaire comprises second semiconductor light sources, which are located on a second straight line and which form the second light source line. The luminaire can comprise further semiconductor light sources, a plurality of which are respectively located on one or more further straight lines, which form one or more further light source lines. The optional straight lines can be aligned parallel, in particular parallel in space, to the first straight line and/or can be arranged in a common light source plane. Optionally present further straight lines are aligned in accordance with the lateral direction. The emittance, i.e., the electrical power consumption of the luminaire in relation to the area covered by semiconductor light sources, can be at least 50 W/cm², in particular at least 100 W/cm², or even at least 150 W/cm². In particular, the emittance can be at least 250 W/cm². In particular, the at least two semiconductor light sources provide a peak radiant power density in the work plane or target plane of at least 5 W/cm², in particular at least 10 W/cm², or even at least 15 W/cm². In particular, the semiconductor light sources provide a peak radiant power density in the target plane of at least 25 W/cm².

The luminaire comprises a plurality of separate lenses, in particular individual, separate lenses, for collimating and/or collecting light from the semiconductor light sources, wherein each of the light source lines is assigned to one of the lenses, in particular on an individual basis. The assignment of each individual light source line to its lens is such that, in particular, the entire light source line is covered by its assigned lens in the lateral direction. The lens covers all semiconductor light sources of the light source line. In particular, a light source line comprises at least 10, at least 20, or at least 30 semiconductor light sources. The lenses are adapted and arranged to direct, more particularly collimate and/or collect, light from the semiconductor light sources. An at least partly transparent and/or translucent optical element that exerts a directing effect (for example, collecting, bundling, collimating, and/or focusing) on radiation passing therethrough can be defined as a lens. In collimating, light rays are directed at least approximately parallel to one another. When focusing, light rays are directed such that they intersect at a point. The at least one lens or the plurality of lenses of the luminaire can comprise glass, in particular borosilicate glass or quartz glass, or consist of glass.

By way of example, at least one lens of the luminaire can be adapted and arranged to direct the light from at least a plurality of semiconductor light sources, in particular different light source lines, onto a predetermined work plane. By “predetermined” is meant determined beforehand, so that the predetermined characteristic must be determined, i.e., chosen or at least known, in advance of some event such as the start of operating the luminaire. The work plane or the irradiation plane can be predetermined relative to the luminaire, in particular in accordance with the distance of the target, for example a process material. In particular, the at least one lens directs the light onto a linear irradiation region in the work plane where a main linear extension direction of the linear irradiation region is in the lateral direction and which has a limited width in the transverse direction. The work plane can be spaced apart at a predetermined distance from the luminaire, in particular from the outer side of a protective window of the luminaire between the target and the lenses, of no more than 20 cm, in particular no more than 15 cm, preferably no more than 10 cm and/or at least 1 mm, in particular at least 2 mm, preferably at least 5 mm, in a radiation direction which is orientated transverse to, in particular perpendicular to, the lateral direction and a transverse direction.

In particular, the lenses can direct the light of the luminaire onto the irradiated surface in such a way that a radiant power density of at least 5 W/cm², in particular at least 10 W/cm², preferably at least 15 W/cm² is obtained in the irradiated surface. In one embodiment, the luminaire can be configured in such a way that the radiant power density in the irradiated surface is at least 20 W/cm² or even at least 30 W/cm². The radiant power density to be achieved can relate to, in particular, the maximum peak power (peak intensity) obtainable in the irradiated surface during continuous operation of the luminaire. To determine the radiant power density, the work plane can be scanned using a measuring device in order to measure the spatially resolved radiant power density in the work plane. By way of example, the Heraeus® NobleProbe® measuring device can be used as the measuring device. The maximum measured value gives the peak power. The measurement is carried out with direct contact between the probe head and the protective window of the emitter, in the transverse direction, centrally above the semiconductor substrates with semiconductor light sources.

The luminaire comprises at least one second light source line, in which at least two further semiconductor light sources are arranged in particular on a second straight line, said second straight line extending, in particular, in the lateral direction with a parallel offset from the first straight line. The outermost semiconductor light source in the lateral direction in the first light source line and the outermost one in the lateral direction in the second light source line can be arranged along a transverse straight line that extends in the transverse direction in a manner transverse to the lateral direction. The next semiconductor light source in the lateral direction in the first light source line and the next semiconductor light source in the lateral direction in the second light source line can be arranged along a second transverse straight line, which extends parallel to the first transverse straight line. According to a specific embodiment, the individual semiconductor light sources of different light source lines can form light source rows which extend in a manner transverse to, preferably orthogonal to, the light source lines and/or in the transverse direction. In the case of such an embodiment, in which the semiconductor light sources form lateral lines and transverse rows, it is possible to speak of a grid-like alignment of the semiconductor light sources. In the transverse direction, the light source lines can be arranged with a constant center pitch from one another. In the transverse direction, the light source lines can be arranged with different center pitches relative to one another. It may be preferable for a luminaire to have at least five semiconductor light source lines, in particular at least seven light source lines and/or no more than 20, in particular no more than 12 semiconductor light source lines. A semiconductor substrate can have at least five and/or no more than 20 light source transverse rows, in particular 12 light source transverse rows.

In particular, a respective lens extends over a respective light source line, at least in sections, in order to collimate and/or collect the light emitted by the semiconductor light sources of this light source line. According to such an embodiment, a first lens can extend over the first light source line, a second lens can extend over a second light source line and possible further lenses can each extend over a further light source line.

According to a preferred development, a luminaire comprises at least one second lens, separate from the first lens, for collimating and/or collecting light from the at least two further semiconductor light sources. Exactly one lens can be provided per light source line in such an embodiment. The lenses can each define lens-individual centerlines, which are arranged in the transverse direction, centrally in the radiation direction, over the respective light source line. In the transverse direction, the lenses can be arranged with a constant center pitch from one another. In the transverse direction, the lenses can be arranged with different center pitches relative to one another. The center pitch of the lenses can correspond to the center pitch of the light source lines situated therebehind in the radiation direction. The center pitch of the lenses can be greater than the center pitch of the light source lines situated therebehind in the radiation direction.

According to one development, the first lens and/or the second lens only extends over one light source line in a transverse direction transverse to, in particular perpendicular to, the lateral direction. Each lens can be individually assigned to a light source line. The width of the first lens, of the second lens, and/or of the further lens in the transverse direction can be greater than the width of a semiconductor light source in the transverse direction. In particular, the width of a lens in the transverse direction is less than the pitch, in the transverse direction, between the two outer light source lines of three adjacent light source lines. In particular, in the radiation direction Z, each lens of the luminaire is situated above no more than one light source line, with, in particular, a lens not being situated above a further, adjacent light source line in the radiation direction.

In particular, the at least one lens or the plurality of lenses forms or form the only effective optical unit of the luminaire. According to one embodiment, the luminaire can have a window or the like, which is arranged behind the lens or the lenses relative to the semiconductor light sources in the radiation direction, but which has no optical effect or practically no effect. A window with no optical effect, or the like, has no significant measurable effect on the collection and/or collimation of the light from the semiconductor light sources. The distance of the semiconductor light sources from the target-facing outer side of the luminaire, in particular the outer side of the window, can be at least 2 mm, in particular at least 4 mm, preferably at least 5 mm and/or no more than 20 mm, in particular no more than 10 mm or 7 mm, preferably no more than 6 mm. By way of example, the distance of the semiconductor light sources from the outer side of the window can be 5.3 mm±0.2 mm.

According to one embodiment of a luminaire, the at least one lens is manufactured as a rod lens, the extension of which in the lateral direction is substantially greater than in a transverse direction transverse to the lateral direction or in a radiation direction transverse to the lateral direction. The length of the rod lens in the lateral direction can be at least 10 mm, in particular at least 25.4 mm or at least 100 mm. According to an alternative embodiment, the length of the rod lens in the lateral direction can be no more than 500 mm, in particular no more than 300 mm or no more than 150 mm. By way of example, the length of the rod lens in the lateral direction can be 370 mm±5 mm or 255 mm±5 mm in one embodiment. According to a specific embodiment, the length of the rod lens in the lateral direction can be at least 250 mm, in particular at least 350 mm or even at least 1,000 mm. As an alternative or in addition thereto, the length of the rod lens in the lateral direction can be no more than 3,000 mm, in particular no more than 2,500 mm or no more than 2,000 mm, in a specific embodiment. By way of example, the length of the rod lens in the lateral direction can be 1,060 mm±50 mm or 1,700 mm±50 mm in a specific embodiment.

The width of the rod lens in the transverse direction or the height of the rod lens in the radiation direction can be less than 10 mm, in particular less than 5 mm or less than 2 mm. In particular, the width of the rod lens can be greater than the height of the rod lens.

According to one embodiment, the at least one lens, more particularly the rod lens, has a constant lens cross section in the lateral direction. In particular, the lens cross section can be circular, shaped like a partial circle, and preferably semi-circular. The lens, more particularly the rod lens, can be shaped as a convex or concave cylindrical lens. In particular, the lens cross section can be shaped like a Fresnel lens. The lens can be shaped as a Fresnel lens. It is conceivable for a plurality of adjacent lenses to have different polyhedron cross sections and to form a composite Fresnel lens together.

According to one embodiment of a luminaire, the at least one lens comprises at least one flat section, in particular wherein the flat section forms a flat side which extends in sections or completely along the lens in the lateral direction. By way of example, the lens can be formed as a rod lens with a constant cross section shaped like a partial circle, preferably with a constant semi-circular cross section. Such a half-cylindrical rod lens-type lens has a convexly curved side and a flat side.

According to one embodiment, which can be combined with other embodiments, the lens is arranged at a distance of no more than 10 mm, no more than 5 mm, no more than 1 mm, or no more than 0.5 mm and/or at least 0.1 mm, at least 0.2 mm, or at least 0.3 mm from the at least two semiconductor light sources in the radiation direction. Preferably, the lens can be arranged at a distance of 0 mm or 0.4 mm from the at least two semiconductor light sources. In particular, the lens can be arranged at a distance of 0.4 mm±0.2 mm from the at least two semiconductor light sources. In particular, the distance extends from a flat section, such as a flat side, of the lens to the semiconductor light sources assigned thereto. In particular, the distance from the lens to the semiconductor light sources of the light source line assigned thereto can be constant. According to a specific embodiment, the respective distance between any semiconductor light source and its respectively assigned lens is constant. The described distance between the lens and the semiconductor light source can, in particular, describe a minimum distance in relation to the respective lens. By way of example, in the case of semiconductor light sources in the form of LED light sources, the distance can be greater than or equal to 0 mm when the LED light sources are embodied as so-called flip-chips or said distance can be greater than or equal to 0.4 mm when the LED light sources are embodied as so-called vertical chips with bonding wires, with the bonding wires, in particular, being arranged in the greater-than-or-equal-to-0.4 mm distance between the vertical chip and lens.

According to one embodiment, the luminaire comprises at least one lens holder which comprises at least one first web with at least one first holder opening and a second web, spaced apart from the first web in the lateral direction, with at least one second holder opening, wherein the at least one lens extends, in the lateral direction, at least from the first holder opening over the light source line to the second holder opening. The lens holder can have multiple parts; in particular, the webs can be individually mountable on the luminaire. The lens holder can comprise more than two webs. More than two webs facilitate the use of particularly long lenses and/or a particularly accurate positioning of the lenses. The webs, i.e., the first web and/or the second web and possible further webs, extend in particular in a transverse direction transverse to, preferably perpendicular to, the lateral direction. According to one embodiment, the webs are orientated relative to the semiconductor light sources of the luminaire in such a way that a web in each case extends in the lateral direction between two immediately adjacent semiconductor light sources of a line in the transverse direction. In the case of a luminaire with a plurality of light source lines, the webs are preferably arranged between respectively adjacent semiconductor light sources of the respective line. This arrangement can minimize the formation of shadows as a consequence of the webs. According to one embodiment, the first web and the second web frame a complete line in the lateral direction. In this embodiment, the lens extends completely over an entire light source line, in particular of one or more printed circuit boards. In particular, the at least one lens extends into the first holding opening and/or the second holding opening. The at least one lens can extend through the first and/or the second holding opening. It may be preferable for the lens holder, the lateral stop, and/or the adjustment mechanism to be formed from a material with high thermal conductivity which is greater than the thermal conductivity of a non-conductive ceramic and/or plastic material.

In the case of a luminaire with a plurality of semiconductor light source lines and a plurality of lenses, provision can be made for the first web and the second web of the lens holder to have a plurality of transversely adjacent first and second openings, corresponding to the number of lenses. In particular, the number of the first holder openings in the first web can equal the number of second holder openings in the second web and can equal the number of lenses and/or the number of light source lines. The number of lenses held by a lens holder preferably corresponds to the number of light source lines of the luminaire.

According to a further embodiment, which can be combined with the other embodiments, the luminaire comprises at least one adjustment mechanism for positioning the lens relative to the at least two semiconductor light sources, said adjustment mechanism being in physical contact, in particular in shape-complementary physical contact, with the lens, in particular with a flat section, preferably a flat side, of the lens. An embodiment with a plurality of light source lines and a plurality of lenses can comprise one, two, or more adjustment mechanisms. The number of adjustment mechanisms can correspond to the number of lenses.

In particular, the lens holder comprises at least one adjustment mechanism. According to a specific embodiment, the lens holder can be formed as one piece with the adjustment mechanism. By way of example, a holder opening may be formed with an adjustment section which is in physical contact, in particular shape-complementary physical contact, with at least one of the lenses. In particular, at least one holder opening is formed, at least in sections or in its entirety, in shape-complementary fashion in relation to the lens cross section. It is conceivable for at least one lens, in particular a flat side of the lens, to be in physical contact, in particular areal physical contact, with a surface of a semiconductor light source, in particular a flip-chip LED light source, so that the surface of the semiconductor light source embodies the adjustment mechanism.

According to an embodiment, the luminaire, in particular the lens holder, comprises at least one lateral holder which is in physical contact with the at least one lens in order to restrict or prevent a relative movement of the lens relative to the lens holder and/or the illuminants in the lateral direction. In particular, the lateral holder can comprise a first lateral stop and a second lateral stop, wherein, in particular, at least one of the lateral stops is in physical contact with opposite lateral ends of the at least one lens. It is conceivable that both opposing lateral stops which are assigned to the same lens are in physical contact with the opposite ends. It is conceivable that a free lateral path in the lateral direction is provided for at least one of the lateral ends of the lens and for at least one lateral stop for the purposes of tolerating thermal expansion of the material of the lateral holder. In particular, the free path can be dimensioned in such a way that a secure holding of the lens by the lens holder is ensured. By way of example, the free path (when the lateral holder is at room temperature) can be at least 0.01 mm, in particular at least 0.1 mm, and/or no more than 2 mm, in particular no more than 0.5 mm. The length of the lens in the lateral direction, particularly when the lens and the lateral holder are heated to the operating temperature, is preferably less than or equal to the distance of the opposing lateral stops assigned to the lens.

According to one development, at least two of the lens holder, lateral holder, and/or adjustment mechanism are formed as one piece. According to one embodiment, the lens holder, the lateral holder, and the adjustment mechanism can be formed by a one-piece sheet body that is bent and perforated multiple times. According to another embodiment, the lens holder is formed by a frame body which comprises at least one pair of circular cylindrical holder openings for receiving the at least one lens, and the lateral holder and the adjustment mechanism are formed in one piece by a profile body which is detachably connected to the frame body, in particular pushed or plugged thereon. The lateral holder and/or the adjustment mechanism can be fastened to the lens holder so as to be detachable, in particular without tools and/or without being damaged.

According to one embodiment, the lens holder, the adjustment mechanism, and/or the lateral holder is or are manufactured from a metal such as aluminum or stainless steel. In particular, the lens holder can be fastened relative to the semiconductor light sources, in particular to the semiconductor substrate. To fasten the lens holder in particular to the semiconductor substrate, for example, clamps, screws or adhesive bonding can be used.

The lens holder, the adjustment mechanism, and/or the lateral holder can be a slab with a slab thickness of at least 1 mm, at least 5 mm, or at least 10 mm. Openings are preferably milled and/or drilled into the slab. According to a specific embodiment, the lens holder can be manufactured as a slab and the adjustment mechanism and/or the lateral holder can be manufactured, in particular in one piece, as a sheet.

The lens holder, the adjustment mechanism, and/or the lateral holder can be a sheet with a sheet thickness of no more than 1 mm, no more than 0.5 mm, or no more than 0.2 mm, in particular approximately 0.5 mm. Openings are preferably introduced into a sheet by laser and/or punching. The sheet can be bent. According to a specific embodiment, a single piece of sheet can embody the lens holder, the adjustment mechanism, and the lateral holder in a functional union.

According to one embodiment of the luminaire, the at least one lens or the plurality of lenses, the lens holder, the adjustment mechanism, and/or the lateral holder are polymer-free. Preferably, the lens, the lens holder, the adjustment mechanism, and/or the lateral holder consists or consist of inorganic materials, for example metal materials, glass materials, and/or ceramic materials. In particular, the luminaire is polymer-free in its region irradiated by the ultraviolet light of the illuminant. If the region of the luminaire irradiated by the light of the semiconductor light sources in both direct and, in particular, indirect fashion is free from polymer materials, in particular free from organic materials, this ensures that there is substantially no material aging as a result of irradiation with ultraviolet light, which could adversely affect the service life of the luminaire.

According to one embodiment, the luminaire comprises a semiconductor substrate on which the semiconductor light sources are arranged. According to one development, the lens holder is electrically insulated relative to the semiconductor substrate and the semiconductor light sources. A non-conductive component can be arranged between the lens holder and the semiconductor substrate. The non-conductive component can comprise air, plastic, ceramic, glass, or the like, or combinations thereof. By way of example, the lens holder can be fastened relative to the semiconductor substrate with the aid of one or more non-conductive spacers, such as washers, for example made from ceramic, and/or by way of non-conductive fasteners such as non-conductive screws and/or non-conductive threaded sockets. In the radiation direction, air can be provided as a non-conductive component between the semiconductor substrate and the semiconductor light source. The non-conductive component or the non-conductive components can be fastened to the lens holder and/or to the semiconductor substrate. Particularly in the case of a lens holder made of a conductive material such as metal, it is advantageous to provide at least one non-conductive component, in particular a plurality of different non-conductive components, between the current-carrying region of the semiconductor substrate and the lens holder in order to avoid a short-circuit between individual current-carrying components of the semiconductor substrate, for example the semiconductor light sources, by way of the lens holder.

According to one development, which can be combined with other embodiments, at least one printed circuit board, such as a chip-on-board module, forms the semiconductor substrate and the at least one lens extends in its entirety over the at least one printed circuit board in the lateral direction. In the case of a luminaire with a plurality of printed circuit boards, these can be assembled and/or disassembled on an individual basis. By way of example, should one printed circuit board be defective, it is only necessary to replace this one. In the case of such an arrangement, an individual lens holder can be assigned to each printed circuit board. By way of example, a plurality of printed circuit boards of the semiconductor substrate, for example two printed circuit boards, three printed circuit boards, or a greater number of individual printed circuit boards, can be assigned a lens holder in which a plurality of lenses are arranged, wherein the one lens or the plurality of lenses extends or extend completely over the plurality of printed circuit boards. In the case of a luminaire with a semiconductor substrate comprising one printed circuit board or a plurality of printed circuit boards, for example two or three printed circuit boards, the plurality of lenses can be configured in such a way that each individual lens spans an entire light source line of the printed circuit board or of the printed circuit boards. By way of example, a semiconductor substrate comprising a plurality of printed circuit boards can be provided, with the printed circuit boards each comprising a plurality of light source lines. In particular, the respective number of light source lines of the plurality of printed circuit boards can be the same. In particular, the light source lines of the plurality of printed circuit boards can be arranged at least approximately flush with one another in the lateral direction. The number of individual light source lines of the printed circuit boards can correspond to the number of assigned lenses, which extend over a plurality of printed circuit boards.

According to one development, an apparatus for drying and/or curing a coating can be provided, which comprises a luminaire according to the invention. By way of example, an areal target, such as a two-dimensional web material, for example a printed product such as a printed paper web, with a coating to be dried applied thereon, for example a printed-on lacquer, can be provided.

The apparatus can be adapted and arranged such that the areal substrate is movable relative to the luminaire within the apparatus, in a conveying direction that corresponds to the transverse direction. Arranged in the apparatus there can be a luminaire or a plurality of luminaires, which extends or extend transverse to the conveying direction at least partially over a width of the areal target, for example the transverse width of a paper web.

The at least one luminaire of the drying apparatus or the plurality of luminaires of the drying apparatus can be arranged at a defined distance relative to the target in the radiation direction. According to a specific embodiment, the apparatus is a printing machine, for example a sheet-feed offset printing machine, a flexographic printing machine, or the like. According to one embodiment, the areal substrate can be a printed product.

The use of a luminaire according to the invention for drying and/or curing a coating, in particular within a printing method and/or a lacquering method, is also to be considered part of the invention. The use of the luminaire for drying is realized by irradiating an applied coating, such as a lacquer, an ink, or the like, preferably within a printing machine.

### BRIEF DESCRIPTION OF THE DRAWING

Particular embodiments and aspects of the invention are described below with reference to the accompanying figures, in which:

FIG. 1 shows an exploded view of a first embodiment of a luminaire according to the invention;

FIG. 2 shows the luminaire as per FIG. 1 in a perspective view;

FIG. 3 shows a second embodiment of a luminaire according to the invention in a perspective view;

FIG. 4 shows a cross-sectional view of the luminaire as per FIG. 3;

FIG. 5 shows a perspective view of a lens holder of the luminaire as per FIG. 3;

FIGS. 6a, 6b, and 6c show different views of a rod lens with a constant semi-circular cross section for a luminaire according to the invention;

FIG. 7 shows a longitudinal sectional view through a schematic illustration of a luminaire according to the invention as per a further embodiment;

FIG. 8 shows a longitudinal sectional view through a schematic illustration of a luminaire according to the invention as per another embodiment;

FIGS. 9a and 9b depict luminaires according to the prior art;

FIG. 10 shows a diagram of the distribution of the radiation intensity in the transverse direction for conventional luminaires and luminaires according to the invention;

FIG. 11 shows a diagram of the radiant flux within an irradiated surface depending on the distance of the irradiated surface from conventional luminaires and luminaires according to the invention;

FIG. 12 shows an apparatus for drying and/or curing a coating, comprising a plurality of luminaires according to the invention;

FIG. 13 shows a perspective view of a further embodiment of a luminaire according to the invention;

FIG. 14 shows the luminaire as per FIG. 13 in an exploded view; and

FIG. 15 shows a perspective view of a lens holder of the luminaire as per FIG. 13.

### DETAILED DESCRIPTION OF THE DISCLOSURE

In the following description of specific embodiments using the figures, the same or similar components have been provided with the same or similar reference signs to aid readability.

A luminaire according to the invention for irradiating a target, such as a printed product with printed-on lacquer, is designated in general by reference sign 1.

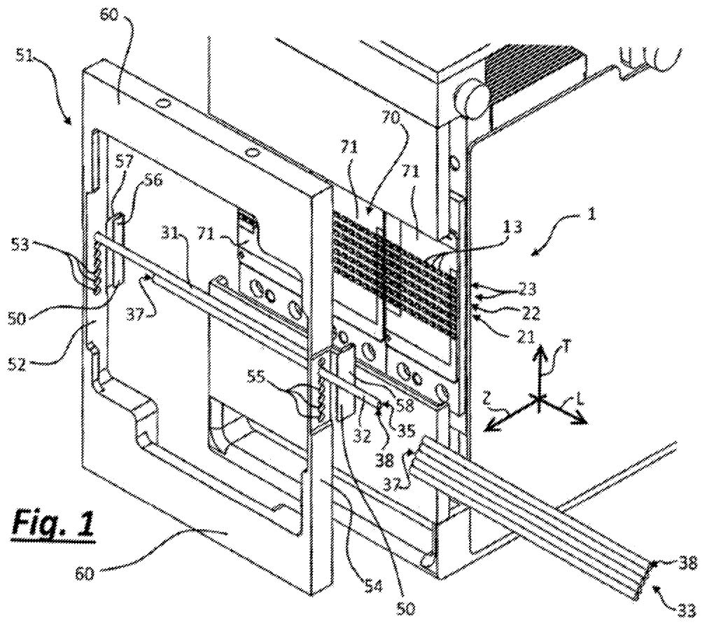

The luminaire 1 illustrated in FIG. 1 comprises a plurality of semiconductor light sources 11, 12, 13, which are arranged in a grid-like fashion. First semiconductor light sources 11 are arranged along a first straight line, which defines a lateral direction L, and form a first light source line 21. A plurality of further (second) semiconductor light sources 12 are arranged along a second straight line, the second straight line arranged parallel to the first straight line, and form a second light source line 22. Further semiconductor light sources 13 are arranged along further straight lines, which lie parallel to the first straight line and the second straight line, and form further light source lines 23.

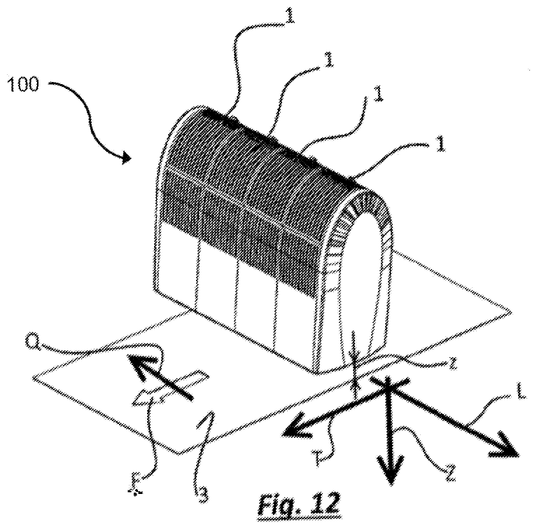

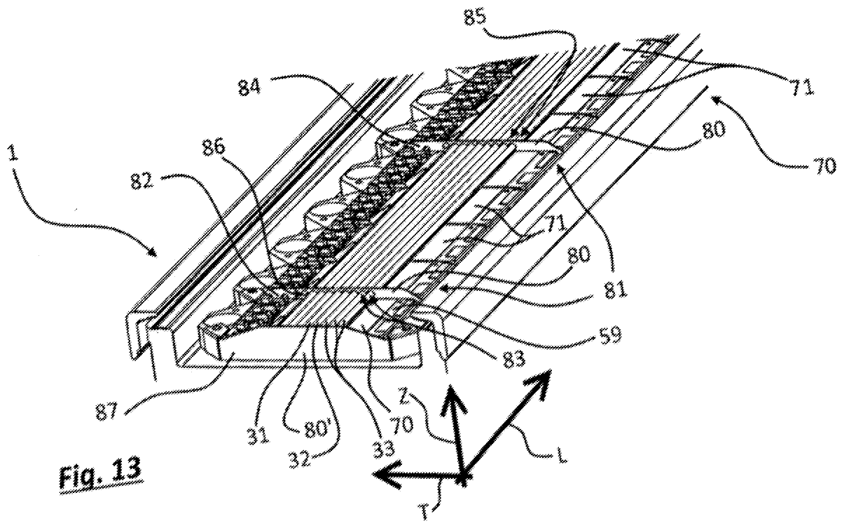

In anticipation of FIG. 12, it is mentioned that, in a specific embodiment, at least one luminaire 1 can be part of an apparatus 100 for irradiating a target 3. The target 3 can be movable relative to the luminaire or luminaires 1 along a conveying direction F. The luminaires 1 emit light, for example ultraviolet light and/or infrared light, in a radiation direction Z. The lateral direction L of the luminaires 1, corresponding to the orientation of the light source lines 21, 22, 23 and/or corresponding to the orientation of the individual lenses 31, 32, 33, corresponds to, in particular, an oblique direction Q of the target 3 transverse to, preferably perpendicular to, the conveying direction F and the radiation direction Z.

In the luminaire 1 as per FIG. 1, individual lenses 31, 32, 33 for collimating and/or collecting light of the semiconductor light sources 11, 12, 13 are assigned to the light source lines 21, 22, 23. In the embodiment illustrated in FIG. 1, an individual lens 31, 32, or 33 is individually assigned to each individual light source line 21, 22, or 23. It is clear that the assignment of a lens to a semiconductor light source is such that the entire light source line is covered by the respective lens. It is conceivable within the scope of the invention for a lens to be able to be assigned to a plurality of light source lines. By way of example, a width BL of a lens in the transverse direction can be dimensioned in such a way that the lens extends over a plurality of adjacent semiconductor light source lines. Independently of the width of the lens or the lenses, it is clear that the assignment of the light source line to its lens (which they can share with other semiconductor light source lines) is such that, in the lateral direction L, the entire light source line is covered by the lens in the radiation direction Z.

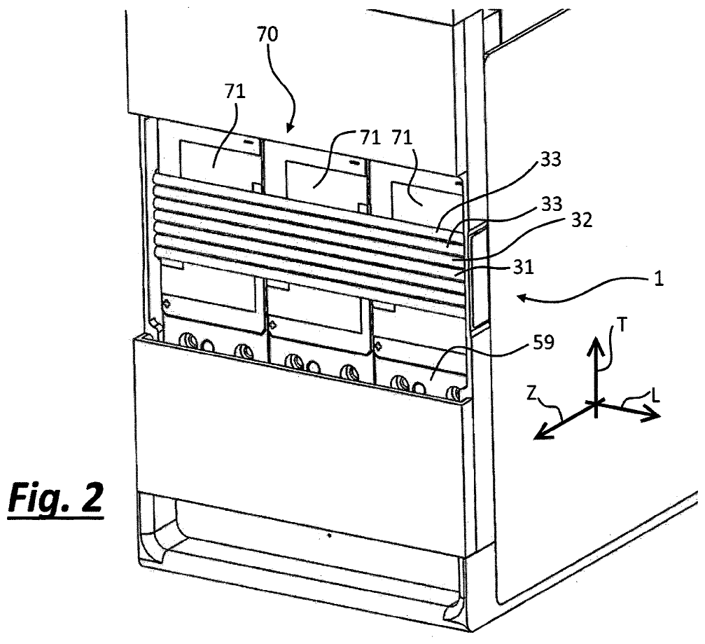

The light source line 21, 22, 23 can comprise at least 5, at least 10, at least 20, at least 30, or more semiconductor light sources. In the case of the luminaire illustrated in FIG. 1, a semiconductor substrate 70 with three printed circuit boards 71 arranged thereon is provided. The printed circuit board 71 is covered by a grid of semiconductor light sources 11, 12, 13. By way of example, the printed circuit board 71 can have at least two, at least three, at least five, or (as depicted here) at least seven light source lines 21, 22, 23. The printed circuit board 71 can have at least five, at least eight, at least ten (as depicted here), at least twelve, at least sixteen, or more light source transverse rows. In the case of the luminaire 1 depicted in FIG. 1, three printed circuit boards 71 are provided which are arranged next to one another in the lateral direction L, comprising semiconductor light sources 11, 12, 13 which are arranged flush in the lateral direction L and which form a semiconductor light source line that is assembled over the width of the luminaire 1 in the lateral direction L and that has at least 20 (30 are depicted) semiconductor light sources 11, 12, or 13 in each case. As shown in FIG. 2, a different rod lens 31, 32, 33 extends completely over each of these light source lines in the lateral direction.

The individual lenses 31, 32, and 33 (which may be rod lenses) illustrated in the case of the luminaire 1 as per FIGS. 1 and 2 each have the same shape. The cross section of the rod lenses 31, 32, and 33 is constantly semi-circular in the lateral direction L along the entire lens length LL. In particular, a high purity quartz glass, which is particularly transmissive (transmission of at least 99%) for ultraviolet light (or infrared light), can be used for the material of the lenses 31, 32, 33. Advantageously, such a quartz glass material can have particularly good mechanical and/or thermal stability. In this way, it is possible to attain particularly high powers, at which lenses made of a polymer material, such as a silicone material, would fail. A lens made of a silicone material can soften and/or overheat in the case of high UV radiant power densities. Compared to polymer materials, borosilicate glass exhibits higher thermal stability and stability against degradation as a result of the UV light.

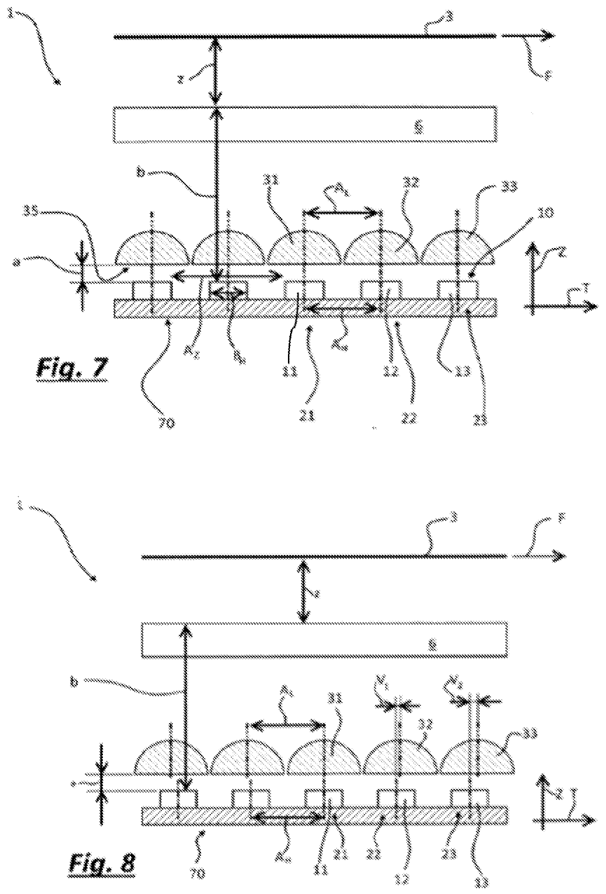

The lenses 31, 32, and 33 are held in a slab-like frame 51, which embodies a lens holder. A protective window 6 (see FIGS. 7 and 8), for example made of glass, in particular made of a quartz glass or borosilicate glass, can be arranged on the side of the slab-like lens holder 51 that faces away from the semiconductor light sources 11, 12, 13 in the radiation direction Z. The lens holder 51 is delimited in the lateral direction L by a first web 52 on one side and by a second web 54 on the other side. The first web 52 and the second web 54 extend substantially parallel to one another in a transverse direction T at longitudinal sides of the lens holder 51 that are opposite one another in the lateral direction L. At their top and bottom ends in the transverse direction T, the webs 52 and 54 are rigidly interconnected by crossbars 60 of the lens holder 51 that extend in the lateral direction L. A non-conductive region 59 is provided between the lens holder 51 and the electronics of the printed circuit boards 70.

Holder openings 53, 55 corresponding to the number of lenses 31, 32, and 33 are respectively provided in the first web 52 and in the second web 54 of the lens holder 51. Each of the lenses 31, 32, and 33 extends in the lateral direction L from a first holder opening 53 in the first web 52 to a second holder opening 55 in the second web 54. The lenses 31, 32, and 33 are preferably dimensioned in such a way that they extend at least in sections into the opposing holder openings 53 and 55.

The lens holder 51 depicted in FIG. 1 is equipped on both sides with a holding and adjustment sheet 50. The adjustment sheets 50 serve in a functional union as lateral stops 57, 58 and as an adjustment mechanism 56 for orienting and securing the lenses 31, 32, and 33 relative to the lens holder 51. The holding and adjustment sheets 50 have a sheet section laterally on the outside, which acts as the lateral stop 57 or 58 by preventing a displacement of the lenses 31, 32, and 33, relative to the lens holder 51 in the lateral direction L, to the outside out of the holder opening 53 or 55.

The holding and adjustment sheets 50 comprise a second sheet section which acts as the adjustment mechanism 56 by contacting a flat side 35 of the lenses 31, 32, and 33, which faces the semiconductor light sources 11, 12, or 13 in the radiation direction Z, along a transverse line edge. The front transverse longitudinal edge of the holding and adjustment sheet 50 in the radiation direction Z easily determines the positioning of the lenses 31, 32, and 33 in the lens holder 51 relative to the semiconductor light sources 11, 12, and 13.

A pair of lateral ends 37 and 38 of the lenses 31, 32, and 33 extend into the drilled or milled holder openings 53 and 55 in the webs 52 and 54 of the lens holder 51. Preferably, neither lateral end 37 and 38, or only one of the two lateral ends 37 and 38, of the lenses 31, 32 and 33 is in physical contact with the first lateral stop 57 or the second lateral stop 58. To avoid damage from thermal stresses, it may be preferable to provide a sufficient tolerance in the lateral direction L between the lateral ends 37 and 38 of the lenses 31, 32 and 33 and the lateral stops 57 and 58. The lens holder 51 and the holding and adjustment sheets 50 are manufactured from metal, in particular the same metal material, for example stainless steel or aluminum.

In the case of the luminaire 1 as per FIGS. 1 and 2, a distance “a” of at least 0 mm, in particular at least 0.1 mm, and no more than 1 mm is provided between the lenses 31, 32, and 33, in particular the flat section 35 thereof, in the radiation direction Z. The back sides of the lenses 31, 32, and 33 in the radiation direction Z can be in physical contact with the LED light sources 11, 12, 13 provided it is ensured by construction that the slab-like lens holder 51 and the holding and adjustment sheets 50 are sufficiently far away from the conductive components of the semiconductor substrate 70 that a short-circuit can be reliably precluded.

The LED light sources are preferably UV and/or IR LED light sources. LED light sources can be contacted on the back side only and can have a flat light-emitting surface 10 (so-called flip-chip LEDs). Vertical chips, which are cheaper than flip-chip LEDs and which are contacted, firstly, on the back side and, secondly, on the light-emitting surface (front side) 10 by way of a bonding wire, can be used in the luminaire 1 according to the invention. If vertical chips with bonding wires are used, the distance between the light-emitting surface 10 of the LED vertical chips and the lenses is chosen to be sufficiently large to be able to provide sufficient space for the bonding wires and possibly an air gap between the bonding wires and possible electrically conductive material of a lens holder, of an adjustment mechanism, and/or of a lateral stop. It is conceivable to bring rod lenses 31, 32, 33 with a back-side flat section 35 into physical contact with the flat, light-emitting front side of flip-chip LEDs or the like such that the semiconductor light source itself can act as an adjustment mechanism.

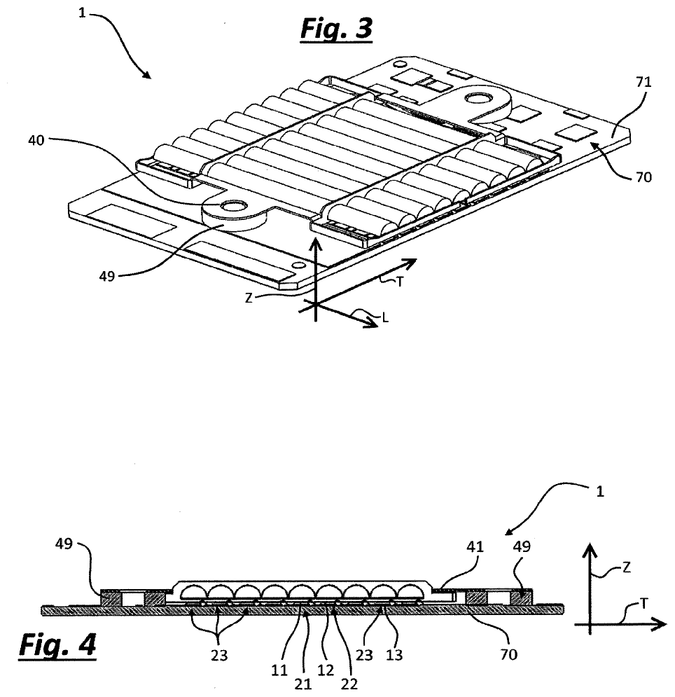

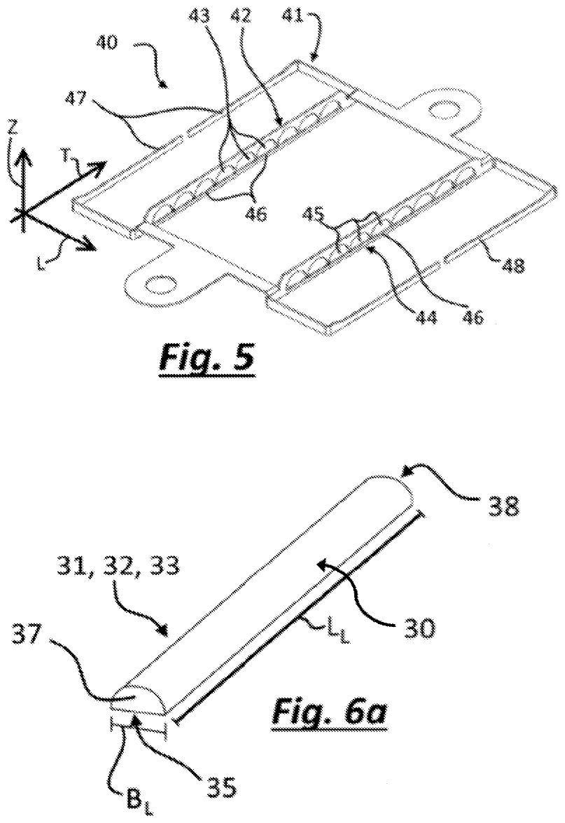

FIGS. 3 and 4 illustrate a second embodiment of a luminaire 1 according to the invention. In relation to the luminaire 1 illustrated in FIGS. 1 and 2, the luminaire 1 illustrated in FIGS. 3 and 4 substantially differs by the different configuration of the lens holder 41, adjustment mechanism 46, and lateral holders 47 and 48, as depicted separately in FIG. 5. In the second embodiment of the luminaire 1 as per FIG. 3, the luminaire 1 comprises a semiconductor substrate 70 with only one printed circuit board 71 arranged thereon, with the printed circuit board 71 having a plurality of semiconductor light sources 11, 12, and 13 arranged thereon in lines 21, 22, and 23. In the embodiment as per FIG. 3, a single lens holder 41 is assigned to a single printed circuit board 71, said lens holder carrying a plurality of lenses 31, 32, and 33 in accordance with the number of light source lines 21, 22, and 23. The lenses 31, 32, and 33 extend over the entire width of the printed circuit board 71 in the lateral direction L. Each individual lens 31, 32, 33 covers the semiconductor light source 11 or 12 or 13 of the respective light source line 21 or 22 or 23.

The lens holder 41 comprises two webs 42 and 44 which are spaced apart from one another in the lateral direction L. A number of holder openings 43 and 45, corresponding to the number of lenses 31, 32, 33 that are held, are provided in each of the two webs 42 and 44 of the lens holder 41. The lenses 31, 32, 33 have the same cross-sectional shape as described for the luminaire 1 as per FIGS. 1 and 2. The lenses 31 and 32 and 33 have a flat side 35 facing the semiconductor light sources 11, 12, and 13 and a convexly curved front side 30 facing away from the semiconductor light sources 11, 12, and 13 in the radiation direction Z. The first holder openings 43 in the first web 42 and/or the second holder openings 45 in the second web 44 are dimensioned in a shape-complementary fashion in relation to the cross-sectional shape of the lenses 31, 32, 33. The holder openings 43 and 45 can be dimensioned in accordance with a loose fit or an oversize fit in relation to the cross-sectional dimension of the lenses 31, 32, 33 in the transverse direction T and/or the radiation direction Z such that a thermal expansion of the lens holder 41 does not result in stresses in the lenses 31, 32, 33. The shape-complementary dimensioning of the holder openings 43 and 45 causes the rearward inner side of the holder openings 43, 45 in the radiation direction Z to act as the adjustment mechanism 46 for positioning the lenses 31, 32, 33.

In the embodiment of the luminaire 1 as per FIGS. 3 to 5, the lens holder 41, adjustment mechanism 46, and lateral holders 47 and 48 are embodied in functional union by a lens-bearing sheet 40. The lens-bearing sheet 40 is delimited in the lateral direction L by bent sheet sections which form the lateral holders (or stops) 47 and 48 to prevent relative movement of the lens relative to the lens holder and/or the illuminants in the lateral direction L. By way of example, the lens-bearing sheet 40 can be shaped from a thin sheet with a thickness of no more than 0.5 mm, in particular of no more than 0.2 mm. By way of example, the lens-bearing sheet 40 can be shaped from a sheet by bending and punching and/or cutting, for example waterjet cutting or laser cutting. By way of example, the holder openings 43 and 45 can be cut or punched into the sheet. The webs 42 and 44 with the holder openings 43 and 45 formed therein can be formed by bending the sheet. The lateral holders or stops 47 and 48 can be formed by punching, cutting, or (as depicted here) multiple bending of the sheet. The lens-bearing sheet 40 can be fastened, for example adhesively bonded, plugged or screwed to the printed circuit board 71 and/or the semiconductor substrate 70 by way of one, two, or more non-conductive fastening components 49.

The webs 42 and 44 are respectively arranged between adjacent transverse row semiconductor light sources 11, 12, 13 in the lateral direction L, the pitch between adjacent semiconductor transverse rows being greater than the thickness of the lens-bearing sheet 40. A non-conductive region filled with air, another gas, or a vacuum is provided between the webs 42 and 44 of the lens-bearing sheet 40 and the semiconductor transverse rows. The lens-bearing sheet 40 is mounted via non-conductive components in a stationary fashion relative to the semiconductor substrate 70 and the semiconductor light sources 11, 12, 13 arranged thereon such that a short-circuit is reliably avoided.

In the embodiment as per FIGS. 3 and 4, the backward flat sides 35 of the lenses 31, 32, 33 are arranged in the radiation direction Z at a distance “a” of at least 0.1 mm, in particular at least 0.2 mm, and/or no more than 1 mm, in particular no more than 0.6 mm, preferably at a distance a of 0.4 mm, relative to the semiconductor light sources 11, 12, 13. The distance “a” is chosen to be as small as possible in order to efficiently focus the emitted light from the LED light sources 11, 12, 13 on the irradiated surface but chosen to be sufficiently large so as to reliably preclude a short-circuit of the semiconductor substrate 70 by the lens-bearing sheet 40.

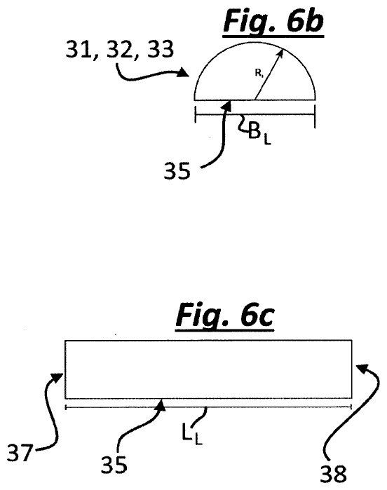

FIGS. 6a, 6b, and 6c show different views of a lens 31, 32, 33, embodied as a rod lens, with a constant semi-cylindrical cross section. As characteristic parameters, the illustrated rod lens 31 has a lens length LL, a lens width BL, and a lens radius RL. In the depicted embodiment, the lens width BL corresponds to twice the lens radius RL. The lens width BL is greater than the width of a semiconductor light source, for example the UV LED 11. The UV LED 11 or other semiconductor light sources can, for example, have dimensions (length times width) of approximately 1×1 millimeter. In particular, the semiconductor light sources can have dimensions of 1,100×1,100±50 μm. A tolerance width between the lateral stops and the lenses of less than 2 mm, preferably 1 mm or less, can be provided in the lateral direction L. A lens whose surface at least partly corresponds to the surface of a cylinder is referred to as a cylindrical lens. The cylindrical lens can have a convex surface. The cylindrical lens can have a concave surface (not illustrated in any more detail). In principle, the lens length LL should measure at least 10-times the lens width BL, independently of whether the rod lens is formed with a semi-circular cross section (as depicted here) or any other cross section.

The length of the lenses LL is at least 20 mm, in particular 25.4 mm or more. The lens length LL can be at least 100 mm or at least 150 mm. It was found to be advantageous to choose the lens length LL to be less than 1,000 mm, in particular less than 300 mm.

FIG. 7 shows a schematic longitudinal sectional view of a luminaire 1 with the emphasis being on the orientation of the light source lines relative to one another, the orientation of the lenses relative to one another, and the orientation of the lenses relative to the semiconductor light sources. The type of holder for the lenses relative to the semiconductor light sources is not illustrated in FIG. 7; by way of example, embodiments as in FIGS. 1 and 2 or as in FIGS. 3 and 4 are conceivable. The same applies to FIG. 8. The differences between FIG. 7 and FIG. 8 will be discussed below.

The longitudinal section of the luminaire 1 as per FIG. 7 schematically illustrates a semiconductor substrate 70 with five light source lines 21, 22, and 23 arranged thereon. Similar rod lenses 31, 32, and 33 are arranged in front of the semiconductor light sources 11, 12, and 13 in the radiation direction Z, an individual rod lens in each case being assigned to a light source line and completely covering the light source line. The protective window 6 of the luminaire 1 is provided in front of the semiconductor light sources 11, 12, and 13 and in front of the rod lenses 31, 32, and 33 in the radiation direction Z. In particular, the protective window 6 is configured in such a way that it has no optical effect or virtually no optical effect on the beam path to the target 3 of the light emitted by the semiconductor light sources 11, 12, and 13. The target 3 can be an areal two-dimensional item, such as a paper web or surface, which can be provided with a coating that can be irradiated by the luminaire 1. Such a protective window 6 usually delimits a housing (not illustrated here) of a luminaire 1 in the radiation direction Z in order to protect the optics and/or electronics from contamination and/or damage. The working distance “z” extends between the target 3 and the luminaire 1 (more precisely, in this case, for example, the front surface of the protective window 6 in the radiation direction Z). It may be preferable to arrange the luminaire 1 and the target 3 in a plane parallel fashion with respect to one another at the working distance z. By way of example, a target 3 such as a printed paper web can be guided, at a working distance z in front of the luminaire 1 in the radiation direction Z, in a conveying direction F that corresponds to the transverse direction T of the luminaire 1 at a working distance z relative to the luminaire 1 (compare FIG. 12).

The distance b between the window front side 6 and the LED front side 10 can be 5.3 mm. In particular, the distance b between the outer side of the luminaire 1, in particular the protective window 6, is at least 4 mm, preferably at least 5 mm, and/or no more than 10 mm, preferably no more than 6 mm.

The lenses 31, 32, and 33 of the luminaire 1 are adapted and arranged to collimate and/or collect the light from the semiconductor light sources, in particular the UV LEDs and/or infrared LEDs, in particular in such a way that the light from the semiconductor light sources 11, 12, 13 is focused on a narrow focal line in the transverse direction T in the work plane defined by the target 3. In this way, it is possible to provide a particularly high peak radiant power density Imax of, e.g., at least 20 W/cm² in the work plane, which may also be referred to as the target plane. In the arrangement of semiconductor light sources 11, 12, and 13 in individual light source lines 21, 22, or 23 and assigned lenses 31, 32, and 33, as depicted in FIG. 7, it is possible to determine centerlines for the semiconductor light sources 11, 12, and 13 and the lenses 31, 32, and 33. In the transverse direction T, the semiconductor light source lines are arranged at a constant, unchanging distance or line pitch AH from one another. In the transverse direction T, the lenses are arranged at a constant, unchanging distance or lens pitch AL next to one another. The centerlines of the lenses are arranged flush with the centerlines of the semiconductor light source lines.

The assembly distance “a” is formed in the radiation direction Z between the light-emitting front side 10 and the back side of the lenses 31, 32, and 33, where the back side is exemplarily formed as a flat side 35. The assembly distance “a” between the light-emitting front side 10 of the semiconductor light source 11, 12, and 13 and the back side of the optically effective lenses 31, 32, and 33 in the radiation direction Z is chosen to be as small as possible. The assembly distance “a” is discussed in more detail above in the context of the different embodiments as per FIGS. 1 and 2 or FIGS. 3 and 4.

As can easily be identified in FIG. 7 (and FIG. 8), the lens width BL in the transverse direction is greater than the width BH of the semiconductor light source 11, 12, 13 in the transverse direction. In the exemplary embodiment illustrated here, the lenses are dimensioned in such a way that the lens width BL is less than the pitch AZ to the light source lines (e.g., 21 and 23) immediately adjacent to the light source line (e.g., 22) covered by the lens. This neighboring line pitch AZ is at least equal to, preferably greater than, the center pitch AH of two immediately adjacent light source lines (e.g., 21, 22). In a different arrangement (not illustrated here), for example in the case of an arrangement with an even number of light source lines, it may be the case that the centerline m is arranged in a region between two light source lines that are adjacent to one another in the transverse direction T. By way of example, the protective glass 6 can be a 3 mm thick, high-purity quartz glass panel.

The curves denoted by reference sign “c” in the graphs of FIGS. 10 and 11 discussed below relate to a relative arrangement of lenses and semiconductor light sources as in the case of the luminaire 1 as per FIG. 7. The curves denoted by reference sign “b” in FIGS. 10 and 11 below relate to an arrangement of lenses and semiconductor light sources as in FIG. 8.

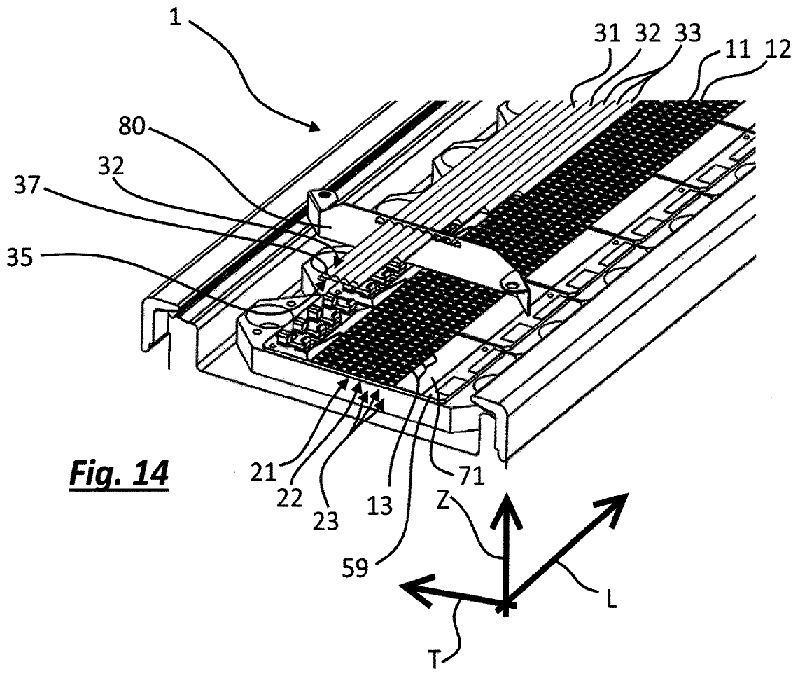

FIG. 8 shows a luminaire 1 which essentially differs from the arrangement as per FIG. 7 by way of a different relative position of the lenses 31, 32, and 33 relative to the light source lines 21, 22, and 23. By way of example, such an arrangement can be realized in luminaires which are embodied as in FIGS. 1 and 2, FIGS. 3 and 4, or FIGS. 13 and 14 (see below). The difference between the arrangements as per FIGS. 7 and 8 consists in the center pitch of the lenses AL in the embodiment as per FIG. 8 being greater than the center pitch of the light source lines AH.

In the exemplary embodiment as per FIG. 8, the number of light source lines is chosen to be odd and the central light source line 21 in the transverse direction T has a centerline m which is arranged flush with the centerline of the lens 31 which is assigned to and covers said light source line. The pitches of the semiconductor light source lines AH relative to one another are the same. The center pitches of the lenses AL in the transverse direction T are the same and constant.

Starting from the transverse center “m” of the semiconductor substrate 70 and going to the outside, there is an increasingly larger transverse offset V1, V2 between the centerlines of the semiconductor light source lines 22 and 23 and the lenses 32 and 33, respectively, assigned thereto. In the depicted embodiment, the offset V1 of the light source line closest to the transverse center “m” of the semiconductor substrate 70, the first transverse offset V1, corresponds to the difference between the lens pitch AL and the light source line pitch AH. The light source line 23 second closest to the transverse center of the semiconductor substrate 70 has an offset V2 in the transverse direction relative to the centerline of the lens 33 assigned thereto. In the example illustrated in FIG. 8, the offset V2 in the case of the second light source line is twice as large as the offset V1 in the case of the first, non-central line 22.

According to the invention, provision can be made, for example, for the center pitch AH of the light source lines 21, 22, and 23 to be non-constant in order to set the offset between different light source lines and the respectively assigned lenses; as an alternative or in addition thereto, the lens center pitch AL can be non-constant (vary) in order to specifically set the offset of light source lines and lenses. Other variations in the arrangement, dimensioning, etc., of semiconductor light sources, light source lines, and/or lenses relative to one another are possible in order to bring about an influence on the optical effect of the lens relative to the semiconductor light sources, for example different offsets.

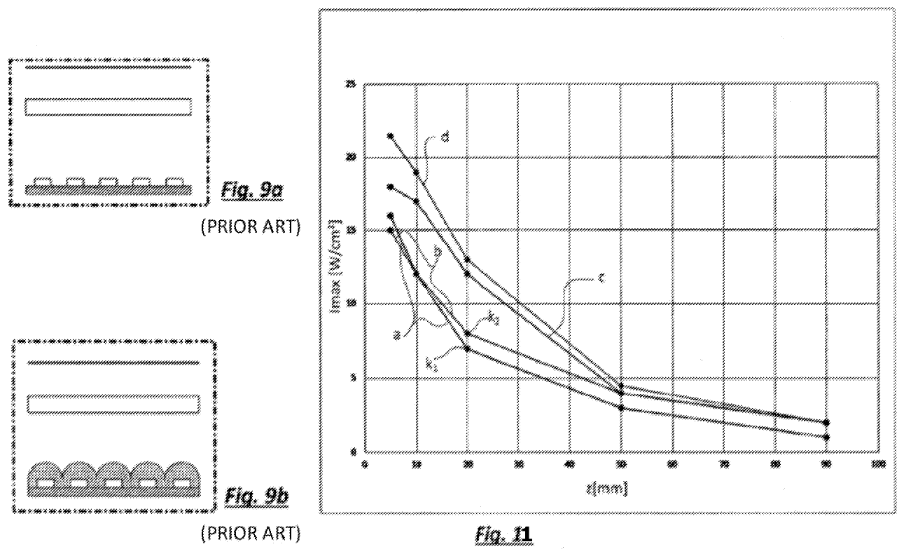

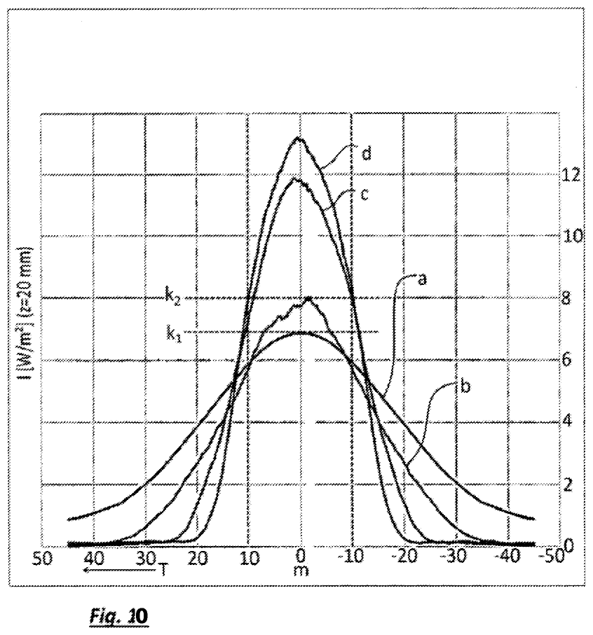

FIGS. 9a and 9b schematically show different luminaires known from the prior art. In accordance with the embodiment of FIG. 9a, a plurality of parallel line UV LEDs which radiate on a target are arranged on a semiconductor substrate. A protective glass practically without refractive power is arranged between the UV LEDs and the target as part of a housing frame of the luminaire, which is not illustrated in more detail. The emitter illustrated in FIG. 9a differs from the prior art emitter illustrated in FIG. 9b in that the semiconductor light sources are individually coated with a silicone potting compound, which forms lenses for the individual UV LEDs. Each individual UV LED is covered by a partly spherical potting compound lens body. In the graphs in FIGS. 10 and 11 described below, the curves relating to luminaires according to the prior art are denoted by reference sign “a” for the embodiment as per FIG. 9a and reference sign “b” for luminaires as per FIG. 9b.

FIG. 10 illustrates graphically the profile of the radiation surface density I in W/cm² in the transverse direction T relative to the center “m” of one of the semiconductor substrates 70 (in millimeters). The semiconductor substrate 70 has a total width of approximately 30 mm, i.e., 15 mm on each side of the centerline m in the transverse direction. In the longitudinal or lateral direction L, the semiconductor substrate 70 has a width of approximately 25 mm. The radiant power density illustrated in FIG. 10 relates to values at a working distance z of 20 mm from the front side of the protective glass 6 of the luminaire 1, which is spaced apart by the distance b=5.3 mm from the light-emitting surface 10 of the semiconductor light sources 11, 12, 13. The radiant flux of the semiconductor light source (1.6 W/LED), i.e., the power consumption of the semiconductor light sources, the number of semiconductor light sources (n=210), the arrangement of the semiconductor light sources, the number of semiconductor light sources in the longitudinal direction (m=30 per substrate), and the number of semiconductor light sources in the transverse direction (w=5) are constant. The profile of the radiant power density curves a, b, c, and d substantially corresponds to a Gaussian distribution about the centerline m in all four cases.

The widest scattering corresponding to the widest curve and the lowest peak intensity Imax of the curve at the working distance of 20 mm is exhibited by the luminaire as per FIG. 9a without an optical element between the semiconductor light source and target. The embodiment as per FIG. 9b has a slightly increased peak intensity in comparison with the embodiments without an optical unit as per FIG. 9a and exhibits a narrower width of the bell, corresponding to stronger focusing.

Surprisingly, curves c and d show significantly better results. It was expected that the optics-free luminaire would exhibit the highest power values due to the lack of absorption by the optical elements. Curves c and d of the luminaires according to the invention exhibit significantly higher peak powers. Curve c of an optical arrangement as per FIG. 7 without an offset between the lenses and the light source lines has a peak power of almost 12 W/cm². Curve b for an optical arrangement as illustrated in FIG. 8 shows a peak power of approximately 13 W/cm², which is almost twice the magnitude of the peak power of the conventional embodiment as per FIG. 9a without an optical element. The measurement values underlying the graph are listed in the following table.

TABLE 1
Power I as a function of the transverse
distance from the substrate centerline m

| | without | | | half cylinder, |
|---|---|---|---|---|
| | optics | half cylinder | silicone | offset |
| | (a) | (c) | (b) | (d) |
| T [mm] | I [W/cm²] | I [W/cm²] | I [W/cm²] | I [W/cm²] |
| −40 | 1.1 | 0.1 | 0.1 | 0.1 |
| −30 | 2 | 0.1 | 0.6 | 0.1 |
| −25 | 2.9 | 0.2 | 1.5 | 0.1 |
| −24 | 3.1 | 0.2 | 1.7 | 0.1 |
| −23 | 3.3 | 0.4 | 1.9 | 0.1 |
| −22 | 3.5 | 0.6 | 2.1 | 0.1 |
| −21 | 3.7 | 0.9 | 2.3 | 0.1 |
| −20 | 3.9 | 1.3 | 2.6 | 0.2 |
| −19 | 4.1 | 1.8 | 2.9 | 0.4 |
| −18 | 4.3 | 2.3 | 3.2 | 0.7 |
| −17 | 4.5 | 2.9 | 3.5 | 1.1 |
| −16 | 4.7 | 3.4 | 3.7 | 1.7 |
| −15 | 4.9 | 4 | 4 | 2.5 |
| −14 | 5.1 | 4.7 | 4.4 | 3.6 |
| −13 | 5.4 | 5.4 | 4.7 | 4.8 |
| −12 | 5.5 | 6.2 | 5.1 | 6 |
| −11 | 5.7 | 7 | 5.3 | 7.1 |
| −10 | 5.9 | 7.9 | 5.7 | 8.1 |
| −9 | 6.1 | 8.5 | 6 | 9 |
| −8 | 6.3 | 9.1 | 6.4 | 9.7 |
| −7 | 6.4 | 9.6 | 6.6 | 10.5 |
| −6 | 6.5 | 9.9 | 6.9 | 11.1 |
| −5 | 6.6 | 10.4 | 7.2 | 11.6 |
| −4 | 6.7 | 10.8 | 7.5 | 12.1 |
| −3 | 6.8 | 11.1 | 7.8 | 12.3 |
| −2 | 6.8 | 11.5 | 7.9 | 12.7 |
| −1 | 6.9 | 11.7 | 8 | 13 |
| 0 | 6.9 | 11.8 | 7.7 | 13.1 |
| 1 | 6.9 | 11.9 | 7.7 | 13 |
| 2 | 6.8 | 11.7 | 7.6 | 12.9 |
| 3 | 6.8 | 11.5 | 7.4 | 12.5 |
| 4 | 6.7 | 11 | 7.4 | 12.1 |
| 5 | 6.6 | 10.6 | 7.3 | 11.6 |
| 6 | 6.5 | 10 | 7.1 | 11 |
| 7 | 6.4 | 9.4 | 6.9 | 10.5 |
| 8 | 6.2 | 8.7 | 6.5 | 9.7 |
| 9 | 6.1 | 8 | 6.2 | 8.8 |
| 10 | 5.9 | 7.4 | 5.7 | 8 |
| 11 | 5.7 | 6.7 | 5.4 | 7 |
| 12 | 5.5 | 6 | 5 | 5.9 |
| 13 | 5.3 | 5.2 | 4.6 | 4.7 |
| 14 | 5.1 | 4.4 | 4.4 | 3.5 |
| 15 | 4.9 | 3.8 | 4 | 2.5 |
| 16 | 4.7 | 3.1 | 3.8 | 1.7 |
| 17 | 4.5 | 2.7 | 3.5 | 1.2 |
| 18 | 4.3 | 2.2 | 3.1 | 0.7 |
| 19 | 4 | 1.8 | 2.9 | 0.5 |
| 20 | 3.8 | 1.4 | 2.7 | 0.3 |
| 21 | 3.6 | 0.9 | 2.4 | 0.2 |
| 22 | 3.4 | 0.6 | 2.2 | 0.2 |
| 23 | 3.2 | 0.4 | 1.9 | 0.1 |
| 24 | 3 | 0.3 | 1.7 | 0.2 |
| 25 | 2.8 | 0.2 | 1.4 | 0.2 |
| 30 | 2 | 0.1 | 0.6 | 0.2 |
| 40 | 1.1 | 0.1 | 0 | 0.1 |

In the transverse region ±10 mm about the centerline m, the luminaires 1 according to the invention have radiant power densities in the region above approximately 7 W/cm² throughout. Thus, the luminaires 1 according to the invention enable a continuously and consistently significantly higher radiant power density in the region of ±10 mm about the centerline m than the peak power k1 of a conventional embodiment (a) and is continuously above the peak power k2 of a conventional luminaire with semiconductor potting compound optics (b).

The graph illustrated in FIG. 11 shows the peak radiant flux for the different luminaires as per FIGS. 7, 8, 9a, and 9b in W/cm², as a function of the working distance z between the luminaire and the target plane. Measurement values for working distances z in the range between 5 mm and 90 mm are illustrated. For the working distance z equal to 20 mm, the maximum radiant power densities k1 and k2 of the conventional luminaires as per FIG. 9a or 9b are illustrated in a manner corresponding to FIG. 10.

The luminaires 1 according to the invention as per the arrangements illustrated in FIGS. 7 and 8 result in significantly higher peak intensities than conventional emitters for working distances between 5 mm and 50 mm. In the working distance range of 50 mm to 90 mm, the peak intensity for the radiation surface density for the arrangement as per FIG. 8 is better than in the case of conventional emitters. It was found that the radiant power density peak intensity for the luminaire 1 according to the invention at a working distance z of between 50 mm and 90 mm is at least as high as in the case of a conventional luminaire.

Apart from the variation of the working distance z, the parameters in the graph as per FIG. 11 are the same as in FIG. 10. The measurement values corresponding with the graph are reproduced below.

TABLE 2
Peak radiant power density or peak power Imax as a function
of the working distance z for different luminaires

| | | | |
|---|---|---|---|
| without | | | half cylinder, |
| optics | half cylinder | silicone | offset |
| (a) | (c) | (b) | (d) |

| | |
|---|---|
| z [mm] | Imax [W/cm\hat{ }2] |

| | | | | |
|---|---|---|---|---|
| 0 | 23 | 19 | 17 | 23 |
| 5 | 16 | 18 | 15 | 21.5 |
| 10 | 12 | 17 | 12 | 19 |
| 20 | 7 | 12 | 8 | 13 |
| 50 | 3 | 4 | 4 | 4.5 |
| 90 | 1 | 2 | 2 | 2 |

FIG. 12 schematically shows an apparatus 100 which comprises four luminaires 1 according to the invention for irradiating the target 3 that is guided in a conveying direction F corresponding to the transverse direction T in the work plane parallel to the luminaires 1.

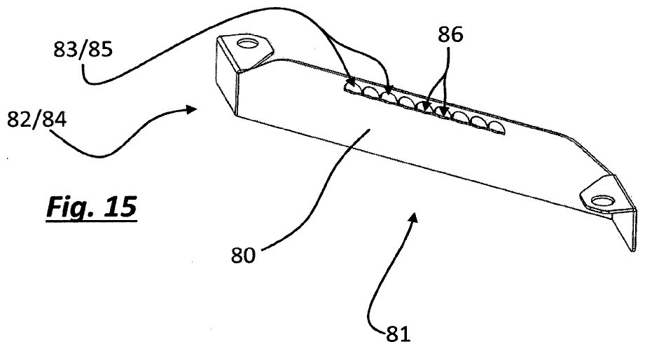

FIGS. 13 and 14 illustrate a further embodiment of a luminaire 1 according to the invention. Compared to the luminaire 1 illustrated in FIGS. 1 and 2, or FIGS. 3 and 4, the luminaire 1 illustrated in FIGS. 13 and 14 essentially differs by the different configuration of the lens holder 81, the adjustment mechanism 86, and the lateral holder 87 (an identical opposing lateral holder is not depicted here). The lens holder 81 is depicted separately in FIG. 15.

The lens holder 81 comprises a first web 82 and a second web 84 as separate individual parts. Provided in each of the webs 82, 84 are a number of holding openings 83, 85 which corresponds to the number of lenses 31, 32, 33 (not depicted in FIG. 15; an outermost lens is not depicted in FIGS. 13 and 14). The holding openings 83, 85 are adapted and arranged to have a complementary shape to the lenses 31, 32, 33 and, as a result, form an adjustment mechanism 86 in accordance with the embodiment as per FIGS. 3 and 4 as described above.

The webs 82 and 84 are embodied in sheets 80 with bent assembly sections. Further stop sheets 80′ without holding openings serve as the lateral stop 87 (the opposite lateral stop is not depicted here). The assembly sections of the sheets 80, 80′ can be affixed to an assembly plate of the luminaire 1 by, for example, screws. The semiconductor substrate 70 can be provided on the assembly plate, with the electrically conductive components being separated from the assembly plate by a non-conductive ceramic layer as the non-conductive region 59, for example an AlN slab. The sheets 80 can be arranged between adjacent printed circuit boards 71 in the lateral direction L such that an air gap and/or a non-conductive ceramic slab section is provided in the lateral direction between the sheet 80 and electrically conductive components of the semiconductor substrate 70.

Although illustrated and described above with reference to certain specific embodiments and examples, the present disclosure is nevertheless not intended to be limited to the details shown. Rather, various modifications may be made in the details within the scope and range of equivalents of the claims and without departing from the spirit of the disclosure.

1. A luminaire for irradiating a target such as a printed product with a printed-on lacquer or the like, comprising,
a plurality of semiconductor light sources, wherein at least two first semiconductor light sources form a first light source line oriented in a lateral direction and wherein at least two further semiconductor light sources form a second light source line oriented in the lateral direction; and
a plurality of separate lenses for collimating and/or collecting light from the semiconductor light sources, wherein each of the light source lines is assigned to one of the lenses.

2. The luminaire as claimed in claim 1, wherein at least one lens of the plurality of separate lenses extends over only one light source line in a transverse direction transverse to the lateral direction.

3. The luminaire as claimed in claim 1, wherein the lenses are manufactured as rod lenses and extend in the lateral direction substantially greater distance than in a transverse direction transverse to the lateral direction and/or than in a radiation direction transverse to both the lateral direction and the transverse direction.

4. The luminaire as claimed in claim 1, wherein at least one lens of the plurality of separate lenses has a constant lens cross section in the lateral direction and the lens cross section is circular, shaped like a partial circle, shaped like a Fresnel lens, or shaped as a convex or concave cylindrical lens.

5. The luminaire as claimed in claim 1, wherein at least one lens of the plurality of separate lenses comprises at least one flat section which extends along the lens in the lateral direction.

6. The luminaire as claimed in claim 1, wherein at least one lens is arranged in the radiation direction at a distance of no more than 10 mm and/or at least 0.1 mm from the at least two first semiconductor light sources.

7. The luminaire as claimed in claim 1, further comprising at least one multi-part lens holder which comprises at least one first web with at least two first holder openings and a second web with at least two second holder openings, said second web being spaced apart from the first web in the lateral direction, wherein a first lens of the plurality of separate lenses and a second lens of the plurality of separate lenses extend at least from respective first holder openings over a respective light source line to respective second holder openings in the lateral direction.

8. The luminaire as claimed in claim 1, further comprising at least one adjustment means for positioning a lens of the plurality of separate lenses relative to the at least two first semiconductor light sources, said adjustment means being in physical contact with the lens.

9. The luminaire as claimed in claim 1, further comprising at least one lateral holder which is in physical contact with a lens of the plurality of separate lenses in order to prevent relative movement of the lens relative to the semiconductor light sources in the lateral direction.

10. The luminaire as claimed in claim 16, wherein at least two of the lens holder, the lateral holder, and the adjustment means are formed as one piece.

11. The luminaire as claimed in claim 16, wherein the lens holder, the adjustment means, and/or the lateral holder are manufactured from a metal.

12. The luminaire as claimed in claim 16, wherein the lens, the lens holder, the adjustment means, and/or the lateral holder are polymer-free.

13. The luminaire as claimed in claim 7, further comprising a semiconductor substrate on which the semiconductor light sources are arranged, wherein the at least one lens holder is electrically insulated from the semiconductor substrate and the semiconductor light sources.

14. The luminaire as claimed in claim 13, wherein at least one printed circuit board forms the semiconductor substrate and the first lens extends completely over the at least one printed circuit board in the lateral direction.

15. A printing machine for producing printed products with a printed-on coating, such as lacquer, printed-on ink, or the like, comprising at least one luminaire as claimed in claim 1.

16. The luminaire as claimed in claim 1, further comprising a lens holder, an adjustment means for positioning a lens of the plurality of separate lenses relative to the at least two first semiconductor light sources, and a lateral holder which is in physical contact with the lens in order to prevent movement of the lens relative to the lens holder and/or the semiconductor light sources in the lateral direction.

17. The luminaire as claimed in claim 16, wherein the lateral holder and/or the adjustment means is detachably fastened to the lens holder.

18. The luminaire as claimed in claim 11, wherein the lens holder, the adjustment means, and/or the lateral holder are manufactured as a slab with a thickness of at least 1 mm.

19. The luminaire as claimed in claim 11, wherein the lens holder, the adjustment means, and/or the lateral holder are manufactured as a sheet with a thickness of no more than 1 mm.

20. A luminaire for irradiating a target such as a printed product with a printed-on lacquer or the like, comprising:
a plurality of semiconductor light sources, wherein at least two first semiconductor light sources form a first light source line oriented in a lateral direction and wherein at least two further semiconductor light sources form a second light source line oriented in the lateral direction;
a plurality of separate lenses for collimating and/or collecting light from the semiconductor light sources, wherein each of the light source lines is assigned to one of the lenses;
at least one multi-part lens holder which comprises at least one first web with at least two first holder openings and a second web with at least two second holder openings, the second web being spaced apart from the first web in the lateral direction, wherein a first lens of the plurality of separate lenses and a second lens of the plurality of separate lenses extend at least from respective first holder openings over a respective light source line to respective second holder openings in the lateral direction;
at least one adjustment means for positioning a lens of the plurality of separate lenses relative to the at least two first semiconductor light sources, the adjustment means being in physical contact with the lens; and
at least one lateral holder which is in physical contact with a lens of the plurality of separate lenses in order to prevent relative movement of the lens relative to the semiconductor light sources in the lateral direction.
